(19) United States
(12) Patent Application Publication
(10) Pub. No.: US 2007/0088857 A1
(43) Pub. Date: Apr. 19, 2007

(54) Using sequestered memory for host software communications

(76) Inventors: Travis Schluessler, Hillsboro, OR (US); David Durham, Beaverton, OR (US); George Cox, Hillsboro, OR (US); Karanvir (Ken) Grewal, Hillsboro, OR (US); Ravi Sahita, Beaverton, OR (US); Priya Rajagopal, Wharton, NJ (US); David Poisner, Folsom, CA (US)

Correspondence Address: TROP PRUNER & HU, PC, 1616 S. VOSS ROAD, SUITE 750, HOUSTON, TX, 77057-2631, US

(21) Appl. No.: 11/241,333

(22) Filed: Sep. 30, 2005

(51) Int. Cl. G06F 3/00

(52) U.S. Cl. 710/8

(57) ABSTRACT

Host software, such as device drivers, may be able to communicate through a platform interface with one another and with adjunct processors. This interface may be provided by enabling such communications to be snooped and then directed through an adjunct or service processor to sequestered memory locations. The sequestered memory locations may be associated with status registers to announce the availability of information transfers. In addition, the sequestered memory may be made relatively invisible to components running on the host system.

### BACKGROUND

A conventional computing platform may include diagnostic and management software tools. An operator may employ these tools to maintain, monitor, and/or troubleshoot the computing platform. Such tools are typically executed within the operating system environment of the platform. Accordingly, the usefulness of these tools is limited if the operating system is compromised or tampered with by a computer worm/virus or malicious user.

An execution environment may be provided that is isolated from operating system processes. For example, a service or adjunct processor may be utilized for management purposes. A service or adjunct processor is any processor that operates in parallel with a main processor. Such a service or adjunct processor may operate, to some degree, autonomously from a main processor associated with the host system. Thus, the host system may include the main processor or processors, as well as host software including device drivers. These device drivers may be privileged or kernel mode software. While device drivers are one example of privileged mode software, other host software is also privileged mode software, such as intrusion detection systems, firewalls, virtual private networks, and virus scanners.

The privileged mode software may interact with the operating system on one side and other devices, such as hardware devices, on the other side. A device driver may be responsible for abstracting a device for the operating system. Thus, the device driver is responsible for configuring and controlling a device. A device driver abstracts device details from the remaining application on the system. By abstracting the hardware through the device driver, the ability of any software to interact with hardware may be facilitated.

### BRIEF DESCRIPTION OF THE DRAWINGS

FIG. 1 is a system depiction of one embodiment of the present invention;

FIG. 2 is a depiction of a memory architecture in accordance with one embodiment of the present invention;

FIG. 3 is a flow chart for one embodiment of the present invention;

FIG. 4 is a flow chart for another embodiment of the present invention; and

FIG. 5 is a flow chart for still another embodiment of the present invention.

### DETAILED DESCRIPTION

One aspect of managing host resources is the interaction of the service processor with the host resident software agents. Host resident software agents may include, without limitation, host device drivers and security software, such as anti-virus or intrusion detection agents. These host software agents may be instrumented to collect a variety of platform management/security data such a network statistics, status of the various devices, disk drive usage statistics, device health statistics, driver version, AV-dat file version, and operating system patch levels, as examples. Such instrumentation data collected by these drivers is critical to the service processor for ascertaining the health of the system. Hence, service processors may retrieve the host management data instrumented by host software components.

In addition to collecting management data, the host devices need to be controlled. Although direct control by the service processor independent of the host operating system may be possible, this can cause system instability issues due to unsynchronized accessing of resources, where the host device driver and service processor are trying to manage the same resource simultaneously. In order to avoid such instability, the service processor may control the host devices through the corresponding host resident drivers, thereby ensuring that the devices registers are only written to by a single entity. Thus, the service processors may configure and control host devices via the host drivers. This type of communication may be insecure and vulnerable to attack by viruses or worms that, due to user neglect or programming errors, infiltrate a kernel, operate at the highest privilege level, and access privileged mode resources directly.

Operating systems typically impose some restrictions on the way device drivers interact with hardware and other device drivers. Failure to comply with these restrictions may cause the drivers to fail operating system vendor (OSV) certification. The main restrictions include: (1) a one-to-one relationship between device drivers and hardware, i.e. one driver must not interact with more than one hardware device and (2) device drivers cannot call functions of another device driver, i.e. there must no dependencies between device drivers. These restrictions limit one driver in the host operating system kernel to only interact with the service processor. This presents an issue when multiple components need to exchange messages with the service processor. Hence there is a need for a scalable solution that will enable multiple host software programs to interact with each other as well as with the service processor.

In accordance with some embodiments of present invention, multiple host software programs are able to interact with each other, as well as a service or adjunct processor, through sequestered memory which may be accessed by the service or adjunct processor. This sequestered memory may be automatically established during the peripheral component interconnect (PCI) device configuration cycle in one embodiment. Thus, host software may communicate with other host software components, as well as the adjunct processor, through dedicated memory space controlled by the service or adjunct processor. This memory space may effectively act as mailboxes for the various host software elements. Thus, host software elements may have an isolated, dedicated address space in which to send and receive messages. As a result, the host software elements may communicate with each other, as well as the adjunct or service processor. This may be done in a way that, in some embodiments, satisfies the requirements of operating system validation rules.

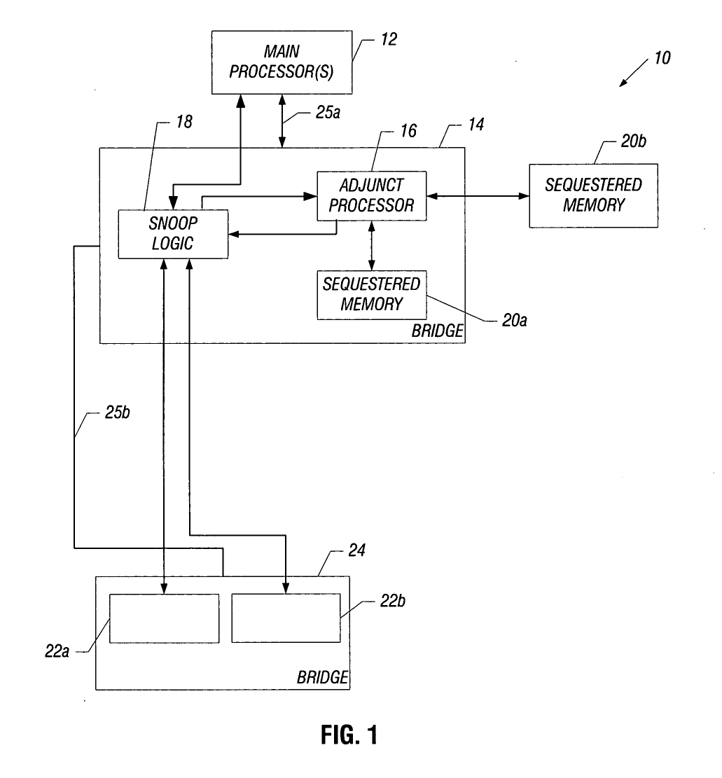

Referring to FIG. 1, a processor-based host system 10 may use any of a variety of computer architectures. For example, in one system, the host system 10 may include an operating system and one or more main processors 12. The host system 10 may interact with a variety of devices coupled to a chipset, memory controller hub (MCH), or north bridge 14 coupled via the bus 25a.

A “host system” as referred to herein relates to a processing system which may comprise a central processing unit (CPU) and system memory for hosting application processes. A host system may be adapted to communicate with a “peripheral device.” For example, a peripheral device may provide inputs to or receive outputs from an application process hosted on the host processing system. However, this is merely an example of a host processing system and embodiments of the present invention are not limited in this respect.

A peripheral device may comprise a “local processing system” for performing computational tasks associated with the peripheral device. The term “local” refers to components coupled to, but not a part of, the host system. A local processing system may comprise a local processor and memory. However, this is merely an example of a local processing system and embodiments of the present invention are not limited in this respect.

A given local hardware device 22 may have associated host software such as a device driver executed by the main processor(s). Such host software may be privileged mode software. A privileged mode is a mode of execution supported by a protected mode of operation in which software can carry out restricted operations that may manipulate critical system components. Thus, the host software may be associated with hardware devices 22 that may be controlled by the host system 10.

Those hardware devices 22 may be coupled to a bridge or input/output controller hub (ICH) 24 coupled to the chipset 14 via the bus 25b. The devices 22 may be network interfaces, disk controllers, or memory controllers, as examples.

The chipset 14 may include an adjunct or service processor 16 in some embodiments. It may also include snoop logic 18 which may be hardware, software, or firmware. In some embodiments, however, the snoop logic 18 and the adjunct processor 16 may be totally separate from one another and/or the chipset 14. In other embodiments, the processor 16 and logic 18 may both be incorporated within a single chipset.

The adjunct processor 16 may comprise any one or more execution units including, but not limited to, a processor, a co-processor, a controller, one or more microengines of a network processor, a virtual machine, a logical partition, and a firmware extension. In some embodiments, the adjunct processor 16 may manage hardware and software resources of the system 10 independently of an operating system environment.

The adjunct processor 16 may work with sequestered memory 20, included within the chipset 14, as indicated at 20a, or external thereto, as indicated at 20b. The adjunct processor 16 may operate independently of the main processor(s) 12 in some embodiments. The adjunct processor 16 may access sequestered memory 20a and/or 20b which, in some embodiments, may be inaccessible to the main processor(s) 12. As a result, malicious software elements may be unable to access the sequestered memory 20 even if they gain improper access to the host system including the main processor or processors 12.

As used herein, “sequestered memory” refers to a memory or memory location that is not accessible to the main processor(s) and is reserved for exclusive use by the adjunct processor 16. A “sequestered memory” may be physically part of the adjunct processor 16 in one embodiment.

Thus, in some embodiments, the adjunct or service processor 16 enables the host system to be an autonomic, self-managed system module that may be used by the main processor(s) 12. The self-management may be the result of the service processor locally monitoring and managing host resources and taking local remedial action in case of a failure. For example, the adjunct processor 16 may manage the hardware devices 22. The adjunct processor 16 may provide an isolated or partitioned execution environment. It may run even when the host system is powered down or not running. In some embodiments, the adjunct processor 16 runs tamper resistance services that may be less open than those normally associated with the main processor(s) 12. The sequestered memory 20 may only be accessible by software running on the adjunct processor 16, preventing access by elements running on the main processor(s) 12.

The snoop logic 18 may be a hardware or firmware component in some embodiments. However, other implementations may also be possible. The snoop logic 18 identifies accesses from host software, such as device drivers associated with devices 22, intended for a special area of memory, for example, the sequestered memory 20a or 20b. When it detects those accesses, the snoop logic 18 directs those accesses to the adjunct processor 16 which then may or may not provide access to the sequestered memory 20. Thus, some communication may be possible, in a fashion to be described hereinafter, between the host software and the adjunct processor 16.

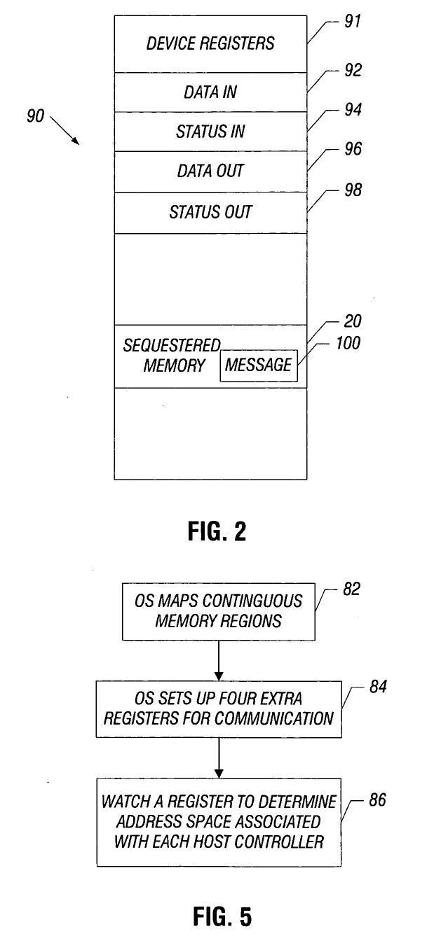

In some embodiments, the sequestered memory 20 may be part of a memory 90, shown in FIG. 2, which includes device registers 91. The memory 90 may be part of the service or adjunct processor 16, may be part of the chipset 14, or may be external and, for example, may be located in a system memory.

Device drivers have full access to their memory mapped register space. Hence, in one embodiment, device memory map register space is configured to include a set of phantom registers which do not actually exist in hardware. In one embodiment, during the peripheral component interconnect device configuration, the chipset 14 configures the device's memory mapped register space to include space for phantom registers. These phantom registers are used for communication from the host software and the adjunct processor. Hence, every time the device driver wishes to communicate with the adjunct processor, it writes to the phantom register space and the snoop logic forwards the data to the sequestered memory region instead, where the adjunct processor can access that data.

The host software may be registered with an operating system and may have full control over its memory mapped device register space. The operating system may simply map a continuous memory region into the Peripheral Component Interconnect (PCI) device space in one embodiment. See PCI 3.0, available from the PCI Special Interest Group, Portland, Oreg. 97221. For example, the chipset 14 may forward memory accesses directed to a specific predetermined range within a device's memory/register space to the adjunct processor's memory/register space. The adjunct processor's memory may be sequestered from host system memory and hidden from the operating system or may be independent memory, with the bridge 14 performing the translation to the adjunct processor's local memory.

When the adjunct processor 16 is sequestering system memory with the complicity of the bridge 14, the performance of these register accesses may be equivalent to direct system memory accesses by the host software for its local memory. The offset at which these phantom registers lie can be predetermined by a platform configuration, either via hard settings or via the basic input/output system, or, as still another example, simply by appending them in a standard way regardless of the device. The term “phantom” is intended to signify that these are not hardware extensions, but, rather, are emulations of memory mapped register space associated with a device.

In accordance with some embodiments, the adjunct processor 16 and snoop logic 18 provide a hardware-based capability that allows host software to own an exclusive message queue or memory region used to send messages to an adjunct processor 16. In addition, host software may have its own protected sequestered memory 20 that can be used to save operational state information and configuration data for the host software. That information might otherwise be corrupted by rogue software running on the host system 10, thereby corrupting the operation of the host software.

A privileged mode component may communicate, in some embodiments, with the adjunct processor 16 by directing the platform to invoke a custom device for that privileged mode component. The interface may allow that privileged mode component to advertise itself as a device driver for such a virtual device spawned on demand by the platform.

Also, the sequestered memory 20 allows multiple privileged mode device drivers and other software components to interact with one another through the platform by passing messages via the adjunct processor 16 and its appended device registers. Thus, dependencies in operating system specific messaging application program interfaces may be reduced in some embodiments.

The registers 92, 94, 96, 98, shown in FIG. 2, may be used to set up a mailbox for messages between the host software and the adjunct processor 16. The host software reads data from the data in register 92 when the status in register 94 specifies that a message is available. The host software can send messages via the data out register 96 and sets the status out register 98 to specify that it has written some data. The host software may also be able to cause interrupts to the adjunct processor 16 by writing to the data out register 96.

The host software knows where the registers are located so that the host software writes to that address space. If an access is to one of these registers, the snoop logic 18 snoops such accesses and sends the accesses to the adjunct processor 16. If the adjunct processor 16 needs to send information to a device controlled by host software, it can write the control information to a register which gets sent to the host software.

It may also be desirable to authenticate the source of data written to these special registers 92-98 since, potentially, by reverse engineering of driver code or reading the source code, programmers may find out the registers used for the mailboxes and, having obtained this information, may spoof these messages. To alleviate this issue, in accordance with some embodiments, techniques can be used to correlate adjunct processor-based code integrity information with processor locality information derived from special processor modes or additional processor registers, instructions, or debug ports.

Any software program, including the host software, may be more uniquely identified by fundamental properties of the program itself, rather than by presenting a key that may be exchangeable with another program. Four fundamental properties of a program may be expressed as: the machine instructions that constitute the software (its code store), the location of the code store memory, the data constituting the software's configuration, and the location of the configuration data in memory. One or more of these fundamental properties of the host software may be used to identify the software program with greater security than is possible through the use of keys or other transferable identifiers, in some cases. Additionally, messages sent from host software to the adjunct processor 16 with an identifier based on one or more of these properties may be authenticated to prove the presence of the correct software program on the host system 10.

The code store may be considered a fundamental piece of the program's identity because a system operates as directed in the machine instructions of the code store. Thus, if an attacker modifies the code store, the system may be programmed to behave as desired by the attacker, rather than as intended in the original program. The integrity of the code store may suggest that the code store has not been altered.

The location of the machine instructions in the memory is also a fundamental piece of the program's identity because a software program is identified by memory management (e.g., hardware and/or code to store objects in memory and/or access objects in memory) at a particular physical location, even if a virtual memory structure is in place on the system. A program stored in a different physical memory location is merely a clone, or a copy of the original program. That copy may be a malicious program pretending to look like the original.

Altered configuration settings may completely change the intended execution of the program. Likewise, the configuration settings may be identified with a physical location by a memory manager.

In one embodiment, identity verification or authentication may be performed using one or more fundamental properties of the host software. Identity verification can determine if host software, originating a message, request, or instruction, is what it purports to be. The program may be identified by fundamental pieces of identity by the authenticating identity (e.g., the adjunct processor 16). In one embodiment, the authenticating entity may validate the integrity of the code store, for example, by obtaining an image of the program associated with an instruction executing on a processor and validating the image. The image may be validated through byte-by-byte comparison, cryptographic hashing, or other techniques.

In one embodiment, the authenticating entity, such as the adjunct processor 16, may validate the location of code associated with an operation by determining the location of memory associated with an executing instruction. Hardware settings associated with the processor execution, such as the value stored in the instruction pointer register or program counter register, may be used to determine the location associated with the instruction executing on a processor.

The source location of the instruction may be determined and compared against a value register at the time the program was loaded into a memory to determine if the instruction actually originated from within the code store of the integrity verified program. A list of validated programs is recorded by the adjunct processor or other entity during the code integrity verification. Hardware settings in a processor may also be used to determine an entry point of the executing instruction, for example, to verify that the instruction not only originated from within the validated program, but is being executed from a proper sequence within the program, and was not simply lifted from elsewhere in the valid program to execute in an invalid manner.

Thus, hardware may be used to authenticate the host software or other message sender to validate that an instruction to be executed is from a valid program and/or code or data sequence associated with a program and that the instruction is being executed from the correct location. These attributes may be considered to be the “what” and “where” associated with a software program. Verification of the “what” and “where” of the program may provide a more secure authentication of the program than traditional software methods involving key exchange, and with less complexity than traditional hardware-based approaches in some cases.

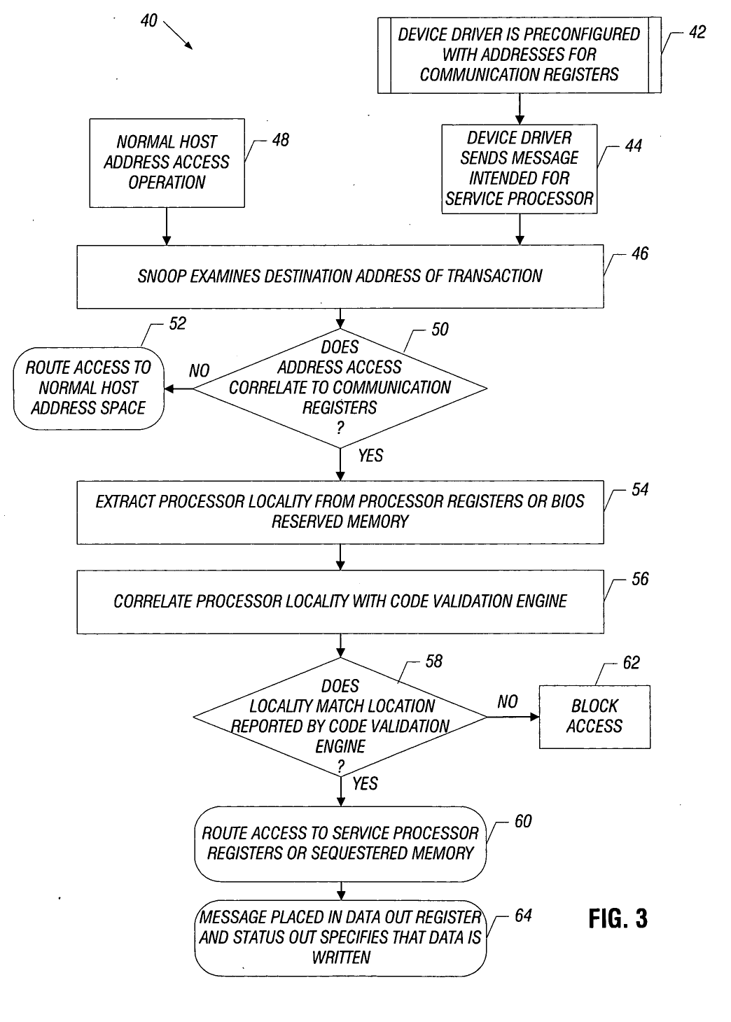

The operation of one embodiment of the present invention in storing information to the sequestered memory is illustrated in FIG. 3 which, in some embodiments, may illustrate hardware, software, or firmware operation. The operation may be begin, as indicated at block 42, with a device driver or other host software that is preconfigured with addresses for communication registers 92, 94, 96, 98 within sequestered memory 20. A device driver or other host software sends a message intended for the adjunct or service processor 16 as indicated in block 44.

The snoop logic 18 examines the destination address of the transaction, as indicated in block 46. If the address of the access correlates to the communication registers 92-98, as determined in diamond 50, the processor locality is extracted from processor registers or basic input/output system reserved memory as indicated in block 54.

The processor locality information is then correlated with the code validation engine as indicated in block 56. The code validation process may be executed by the adjunct or service processor 16. If the locality information matches the validated code images as recorded by the code validation engine (diamond 58), the access is routed to adjunct processor 16 registers or sequestered memory 20 as indicated at 60. Finally, the message is placed in the data out register 96 and the status out register 98 specifies that the data is available for access as indicated in block 64. Of course, if the processor locality information does not match at diamond 58, the access is blocked (block 62).

Normal host address accesses (block 48) are not snooped and, instead, are passed through essentially obliviously to the operations indicated in FIG. 3. If an access does not correlate to one of the communication register's address space, normal accessing procedures may be used as indicated at 52.

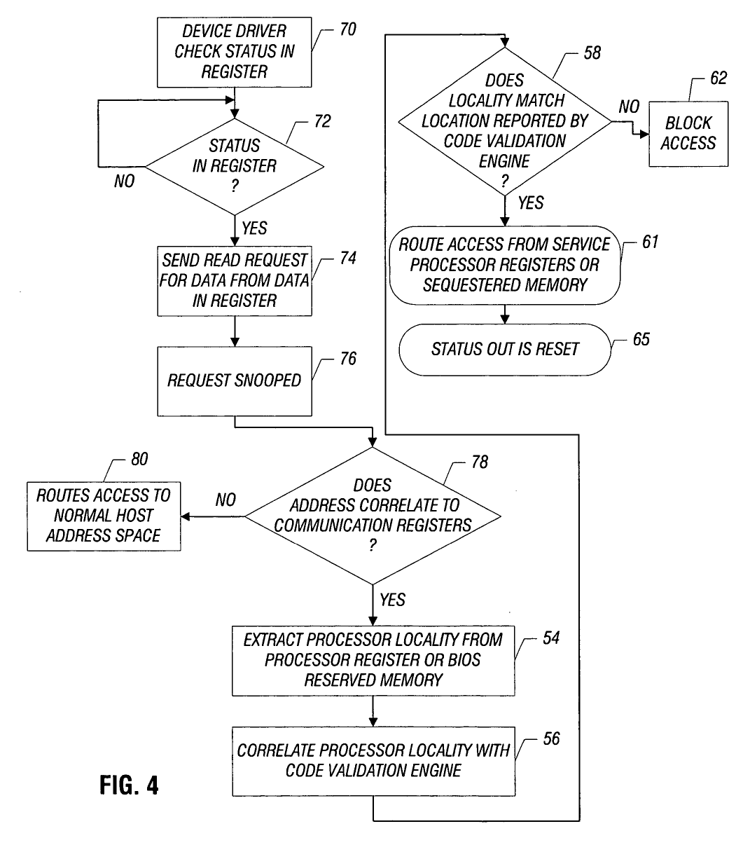

The action of actually reading data from the sequestered memory 20 or processor registers is illustrated in FIG. 4 for one embodiment. Again, the actions set forth in FIG. 4 may be performed by software, hardware, or firmware. There, the action begins at block 70, with the host software checking the status in register 92. If the status in register 92 indicates that data is available, as determined in diamond 72, a read request for the data is sent to the data in register 94 as indicated in block 74. The request is snooped by the snoop logic 18 in the bridge 14 as indicated in block 76. A check at diamond 78 determines whether the snooped address correlates to any of the communication registers 92, 94, 96, 98 and, if so, the access is handled at 54, 56, 58, 60, 61, 68, as described previously in connection with FIG. 3. Otherwise, the request is accessed normally as indicated at 80.

Specifically, if the code validation is successful in blocks 54, 56, 58, the access is routed from the service processor registers to the host software as indicated in block 61. The status out register is then reset (block 65).

Finally, referring to FIG. 5, the sequence for setting up the mailbox system already described is illustrated and may be implemented in hardware, software, or firmware. Initially, the operating system may map contiguous memory regions within the sequestered memory 20 or processor 16 registers as indicated in block 82. The operating system may also automatically set up four extra registers for communications (block 84), those registers being the registers 92, 94, 96, 98, shown in FIG. 2.

Then, the bridge 14 watches the registers to determine the address space associated with each host software, as indicated in block 86, during the PCI enumeration process. In other words, the bridge 14 learns what address space is associated with each host software and, thereby, learns which address spaces are associated with the host software.

The host system 10 executes a scan to discover what bus devices 22 are present. The enumeration procedure identifies devices 22 coupled to the host system 10 via buses 25 and allocates processing resources for facilitating communications with the bus devices. The host system 10 may address those devices 22 in a bus configuration. In response to such commands, a targeted device 22 may return configuration header and descriptor information characterizing the device. As one result of enumeration, the location or addresses of bus devices 22 may be determined.

Extra phantom registers may then be associated with the host software. The bridge 14 may include the snooping logic 18 for driver-to-adjunct processor 16 reads and writes. The host controllers for the host software may be assumed to be at a fixed bus, device, and function addresses. The bridge 14 snoops the memory reads and writes to PCI base address registers (BARs) associated with these fixed devices to determine the memory spaces allocated by the basic input/output system and/or operating system.

In other words, a base address is set, say by the operating system, to map a device into the PCI address space and the bridge 14 watches the register to determine where a memory device has been mapped. The bridge 14 then snoops the phantom register addresses appended to the host controllers for adjunct processor-to-host software messages. These addresses are memory spaces associated with the phantom registers.

The bridge 14 may also allow for adjunct processor-to-host software interrupts in some embodiments.

The adjunct processor 16 may be able to access these memory regions, having them memory mapped into the adjunct processor 16 accessible memory region. The adjunct processor 16 may also be able to emulate device interrupts to specific drivers.

Some embodiments create a platform interface that programs can interact with independently of any particular operating system. In some embodiments, this interface may enable trusted stacks, such as network, storage, or video stacks, that cannot be circumvented or compromised by malware, even where malware is running at the same or a higher privilege level. Other embodiments may allow separate device drivers to communicate with one another through the platform interface, independently of the operating system, through an adjunct processor. Still other embodiments may allow device driver operation memory space to be managed by the platform, and shared and mapped between other device drivers.

In some embodiments, the platform interface has the highest performance driver-to-driver and driver-to-adjunct processor communications, equivalent to direct memory accesses by programs over a front side bus. Some embodiments may also avoid any hardware compatibility issues, such as those associated with the Microsoft Windows® Hardware Qualification Laboratory, since each device driver accesses only the register map for the device it owns.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
enabling host software to communicate with a local entity using a storage location dedicated for that host software.

2. The method of claim 1 including enabling host software in the form of device drivers to communicate with said entity.

3. The method of claim 1 including providing as said storage location a storage location that is not accessible by a host processor.

4. The method of claim 3 including providing sequestered storage accessible by an adjunct processor.

5. The method of claim 1 including providing an adjunct processor having access to a sequestered storage and using said sequestered storage to enable communications between device drivers and the adjunct processor.

6. The method of claim 5 including snooping accesses from host software to particular addresses and redirecting such accesses to the adjunct processor.

7. The method of claim 6 including providing phantom registers including a status register for data inputs to said storage location, a status register for data outputs from said storage register, a data in register, and a data out register.

8. The method of claim 7 including establishing said registers automatically during a device configuration process.

9. The method of claim 1 including providing locality information to provide integrity verification of host software communicating with an adjunct processor via said storage location.

10. The method of claim 1 including enabling device drivers to communicate with one another through said storage location.

11. A machine-accessible medium having instructions that, when executed, cause a system to:
enable host software to communicate with a local entity using a storage location dedicated for the host software.

12. The medium of claim 11 further having instructions to enable host software including device drivers to communicate with said entity.

13. The medium of claim 11 further having instructions to provide as said storage location a storage location that is not accessible by a host processor.

14. The medium of claim 13 further having instructions to provide sequestered storage accessible by an adjunct processor.

15. The medium of claim 11 further having instructions to provide an adjunct processor having access to a sequestered storage and use said sequestered storage to enable communications between device drivers and the adjunct processor.

16. The medium of claim 15 further having instructions to snoop accesses from host software to particular addresses and redirecting such accesses to the adjunct processor.

17. The medium of claim 16 further having instructions to provide registers including a status register for data inputs to said storage location, a status register for data outputs from said storage register, a data in register, and a data out register.

18. The medium of claim 17 further having instructions to establish said registers automatically during a device enumeration process.

19. The medium of claim 11 further having instructions to provide locality information to provide authentication for host software communicating with an adjunct processor through said storage location.

20. The medium of claim 11 further having instructions to enable device drivers to communicate with one another through said storage location.

21. An apparatus to operate in a system including a main processor, said apparatus comprising:
an adjunct processor;
a memory associated with said adjunct processor, said memory accessible by said adjunct processor and not accessible by the main processor; and
snoop logic to snoop accesses to designated addresses and to forward those accesses to the adjunct processor.

22. The apparatus of claim 21 wherein said apparatus is a bridge.

23. The apparatus of claim 21 wherein said apparatus is a memory controller hub.

24. The apparatus of claim 21 adapted to enable host software to exchange messages with said adjunct processor.

25. The apparatus of claim 21 including dedicated memory locations for each of at least two device drivers.

26. A system comprising:
a main processor;
a service processor;
a memory accessible by said service processor and not by said main processor; and
snoop logic to snoop accesses to designated addresses and to forward those accesses to the service processor.

27. The system of claim 26 wherein said snoop logic and service processor are included in a bridge.

28. The system of claim 26, said service processor to facilitate the exchange of messages between at least two device drivers.

29. The system of claim 26 wherein said service processor to control access to said memory, said memory including a dedicated location for each of at least two device drivers.

30. The system of claim 29 wherein each of said locations is dedicated for a different one of said two device drivers to enable said device drivers to communicate with said service processor and with each other.
